(19) United States
(12) Patent Application Publication
(10) Pub. No.: US 2012/0162068 A1
(43) Pub. Date: Jun. 28, 2012

(54) Method of Controlling Remote Controller, Remote Controller, and Display System

(76) Inventors: Shoichi Yokobori, Hanno-shi (JP); Hirokazu Nagata, Meguro-ku (JP); Tomotaka Ida, Kumagaya-shi (JP)

(21) Appl. No.: 13/275,959

(22) Filed: Oct. 18, 2011

(30) Foreign Application Priority Data
Dec. 22, 2010 (JP) 2010-286619

(51) Int. Cl. G06F 3/033

(52) U.S. Cl. 345/157

(57) ABSTRACT

According to one embodiment, there is provided a method of controlling a remote controller that comprises a first key configured to move a focus displayed on a display screen, a second key configured to move a pointer displayed on the display screen, and a third key configured to instruct determination operation at a focus position or selection operation at a pointer position. The method includes receiving operation on the remote controller, and switching operations to be instructed by the third key according to the last operation received at the receiving.

### CROSS-REFERENCE TO RELATED APPLICATIONS

This application is based upon and claims the benefit of priority from Japanese Patent Application No. 2010-286619, filed Dec. 22, 2010, the entire contents of which are incorporated herein by reference.

### FIELD

Embodiments described herein relate generally to a method of controlling a remote controller, a remote controller, and a display system.

### BACKGROUND

Generally, equipment such as television receivers, video players, digital versatile disc (DVD) players, and set-top boxes can be remotely operated using a remote controller provided to the equipment. Such a remote controller has various keys for performing the functions of the equipment. There have been proposed remote controllers provided with an arrow key for sequentially moving a focus to an option item and a pointing device such as a trackball for freely moving a pointer on a screen to improve the operability.

Between determination operation at a focus position and selection operation at a pointer position each instructed by pressing a predetermined key, instructions are different with respect to the object of the operation. Accordingly, the operations are generally treated as different events. For this reason, on a personal computer (PC) or the like, the enter key of a keyboard and a single click on a mouse are separately used depending on whether to instruct the determination operation at a focus position or the selection operation at a pointer position.

On the other hand, to move a focus or a pointer, a remote controller needs operation keys to instruct the determination operation at a focus position and the selection operation at a pointer position. Especially on the remote controller, a key to operate a focus and a key to operate a pointer are often closely arranged. With such an arrangement, from the viewpoint of operability, the determination operation at a focus position and the selection operation at a pointer position are desirably operated with the same operation key. As described above, in conventional technology, these operations are treated as different events, and therefore, are separately assigned to different operation buttons. Thus, there is room for improvement in operability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a display system according to an embodiment;

FIG. 2 is an exemplary top view of a remote controller in the closed state in the embodiment;

FIG. 3 is an exemplary cross-sectional view of the remote controller taken along line A-A in FIG. 2 in the embodiment;

FIG. 4 is an exemplary top view of the remote controller in the open state in the embodiment;

FIG. 5 is an exemplary cross-sectional view of the remote controller taken along line B-B in FIG. 4 in the embodiment;

FIG. 6 is an exemplary enlarged schematic view of an arrangement portion of a direction key and a center key in an upper housing illustrated in FIG. 2 in the embodiment;

FIG. 7 is an exemplary schematic diagram illustrating the slide operation of the center key in the embodiment;

FIG. 8 is an exemplary block diagram of a hardware configuration of the remote controller in the embodiment;

FIG. 9 is an exemplary table indicating correspondence between the key type and the event type of the remote controller in the embodiment;

FIG. 10 is an exemplary diagram illustrating the state transition of the event type set to the press operation of the center key in the embodiment;

FIG. 11 is an exemplary timing chart of the state transition illustrated in FIG. 10 in the embodiment;

FIGS. 12 to 16 are exemplary schematic diagrams for explaining the operation of a broadcast receiver during receipt of an event code in the embodiment;

FIG. 17 is an exemplary schematic view of the remote controller comprising an indicator capable of presenting the event type in the embodiment; and

FIG. 18 is an exemplary diagram illustrating another example of the state transition of the event type set to the press operation of the center key in the embodiment.

### DETAILED DESCRIPTION

In general, according to one embodiment, there is provided a method of controlling a remote controller that comprises a first key configured to move a focus displayed on a display screen, a second key configured to move a pointer displayed on the display screen, and a third key configured to instruct determination operation at a focus position or selection operation at a pointer position. The method comprises receiving operation on the remote controller, and switching operations to be instructed by the third key according to the last operation received at the receiving.

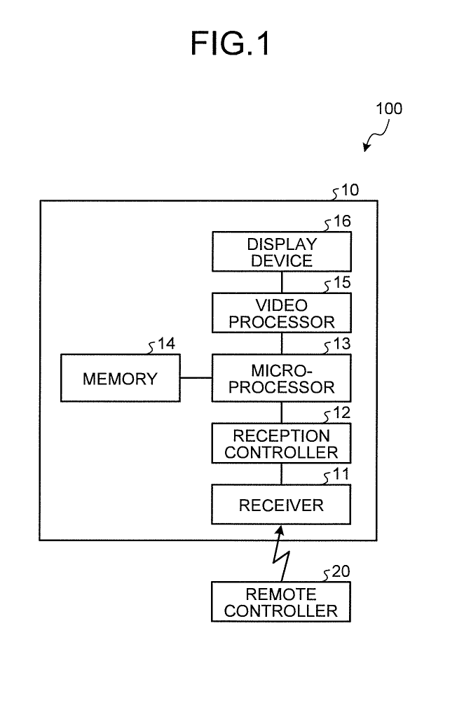

FIG. 1 is a block diagram of a configuration of a display system 100 according to an embodiment. As illustrated in FIG. 1, the display system 100 comprises a broadcast receiver 10 and a remote controller 20.

The broadcast receiver 10 is an electronic device such as a television receiver, a video player, a digital versatile disc (DVD) player, or a set-top box, and comprises a receiver 11, a reception controller 12, a microprocessor 13, a memory 14, a video processor 15, and a display device 16.

The receiver 11 is capable of receiving signals (event codes, which will be described later, and the like) from the remote controller 20. The system of signals received by the receiver 11 is according to the specifications of the remote controller 20, and, for example, a system using radio communication, such as infrared rays and Bluetooth (registered trademark), is applicable. The reception controller 12 controls the receiver 11 and feeds a signal received by the receiver 11 to the microprocessor 13.

The microprocessor 13 cooperates with various computer programs and various types of setting information stored in the memory 14 to control the overall operation of the broadcast receiver 10.

Specifically, the microprocessor 13 controls the video processor 15 to display on the display device 16 a video signal (such as a terrestrial analog broadcast wave, broadcasting satellite (BS), communication satellite (CS), and terrestrial digital broadcast waves) received by a tuner (not illustrated) or a video signal input through an input interface (not illustrated). The microprocessor 13 also controls the video processor 15 to display various graphical user interfaces (GUIs) on the display device 16.

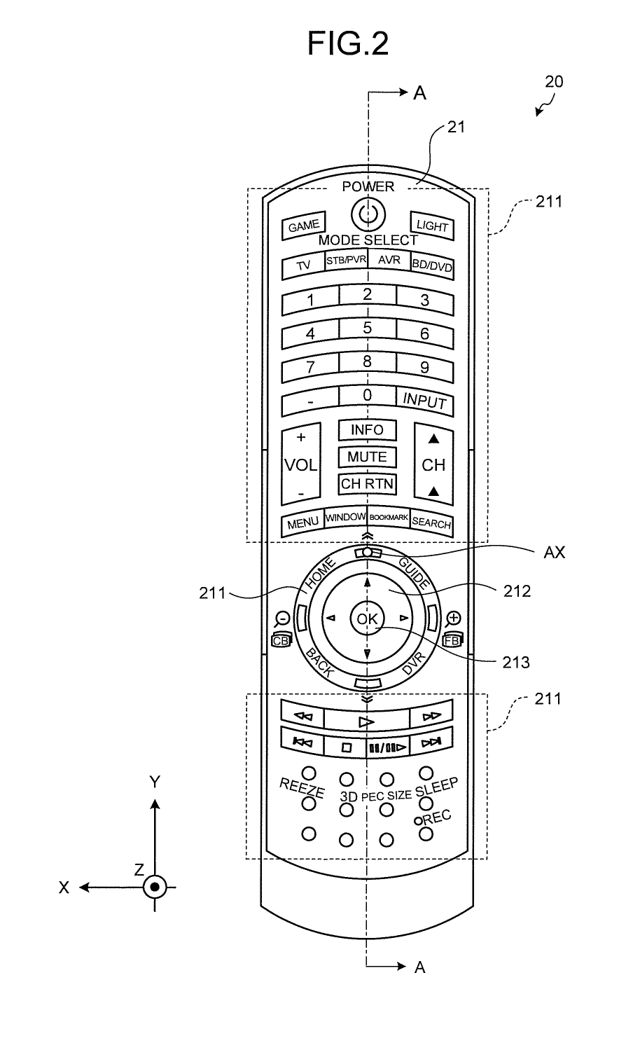

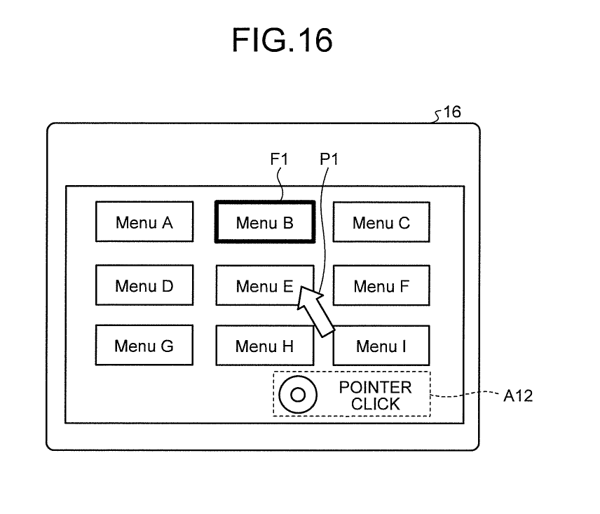

The microprocessor 13 issues an instruction for on screen display (OSD) of a focus, a pointer, and the like to the video processor 15 according to a signal received by the reception controller 12. Specifically, the microprocessor 13 determines an event type set to the press operation of a center key 213 (see FIGS. 2 to 7) of the remote controller 20 based on the event type of an event code, which will be described later, transmitted from the remote controller 20. The microprocessor 13 then displays an image (OSD) representing the event type (see FIGS. 12 to 16) on the display device 16.

The memory 14 is a nonvolatile storage medium and stores various computer programs to be executed by the microprocessor 13 and setting information.

The video processor 15 is a functional module that controls video (image) to be displayed on the display device 16 under the control of the microprocessor 13. Specifically, the video processor 15 performs predetermined signal processing on a video signal and outputs the signal to the display device 16, thereby displaying the video on the display device 16. The video processor 15 superimposes an OSD signal such a focus and a cursor on a video signal and outputs the signal to the display device 16 according to an instruction from the microprocessor 13 to display the video on the display device 16.

The display device 16 comprises a display such as a liquid crystal display (LCD), and displays video corresponding to a video signal output from the video processor 15. The display device 16 may be built in the broadcast receiver 10 or may be provided to the broadcast receiver 10 as an external device.

The remote controller 20 is used to remotely control or operate the broadcast receiver 10 and sends various signals (event code, which will be described later, and the like) according to the operation performed by the user to the broadcast receiver 10. The basic configuration of the remote controller 20 will be described below with reference to FIGS. 2 to 6.

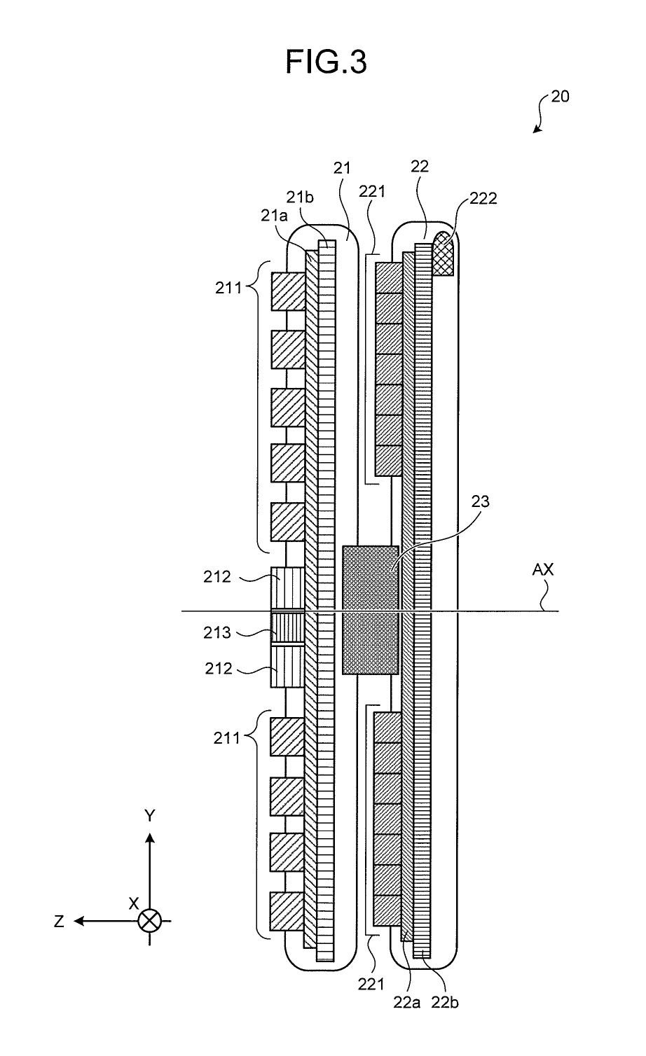

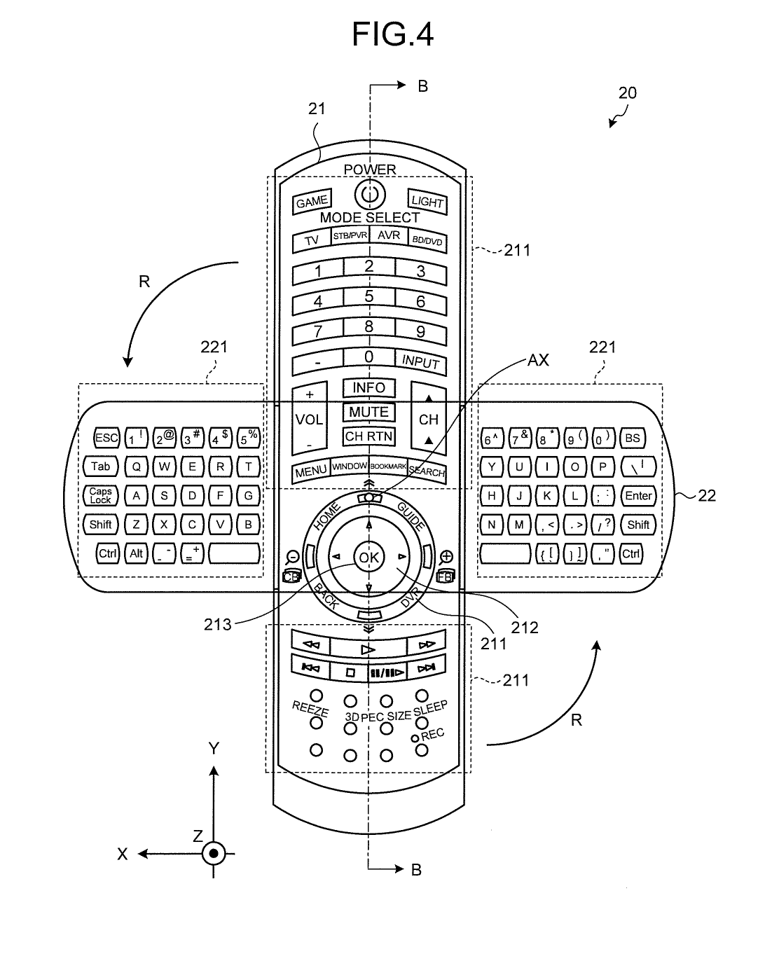

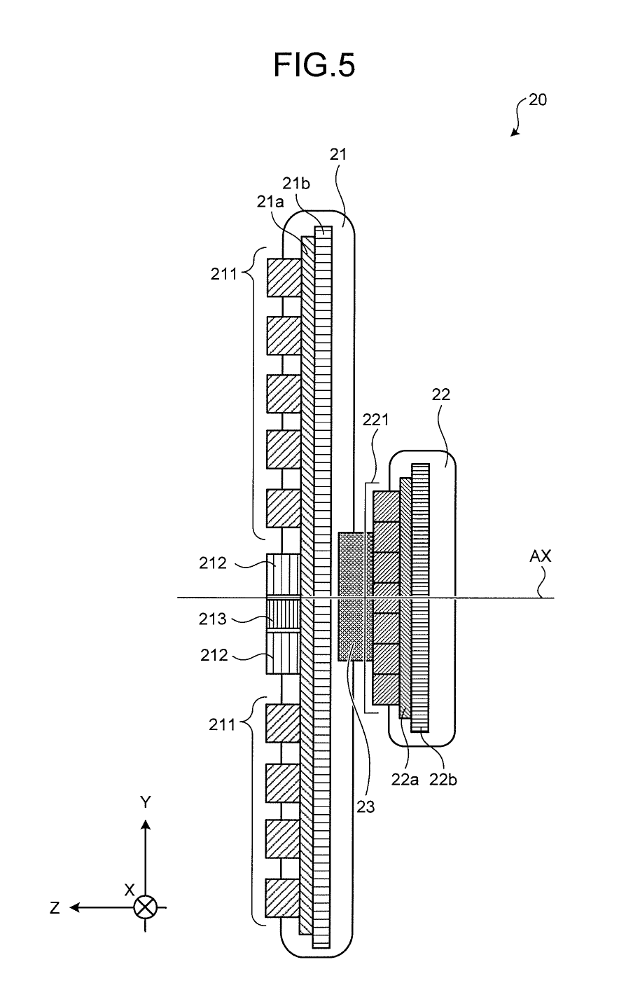

FIG. 2 is a top view of the remote controller 20 in the closed state. FIG. 3 is a cross-sectional view of the remote controller 20 taken along line A-A in FIG. 2. FIG. 4 is a top view of the remote controller 20 in the open state. FIG. 5 is a cross-sectional view of the remote controller 20 taken along line B-B in FIG. 4.

As illustrated in FIGS. 2 to 5, the remote controller 20 comprises an upper housing 21 as a substantially rectangular parallelepiped first housing, a lower housing 22 as a substantially rectangular parallelepiped second housing, and a rotatable joint 23 that connects the upper housing 21 and the lower housing 22 to be relatively rotatable about a rotation axis AX as the center. The upper housing 21 and the lower housing 22 have substantially the same outer edge as viewed in the rotation axis AX direction (Z-axis direction) of the rotatable joint 23.

An operation key group 211, a direction key 212 serving as a first key, and the center key 213 serving as both a second key and a third key are arranged on an operation surface, i.e., the upper surface of the upper housing 21. The operation key group 211 is used to, for example, perform main functions of a device to be remotely operated (hereinafter, referred to as “operated device”), such as channel selection and volume control. The direction key 212 is used to move a focus displayed on the display screen of the operated device. The center key 213 functions as a pointing device for moving a pointer displayed on the screen of the display device 16 and also has a function to perform various determination operations.

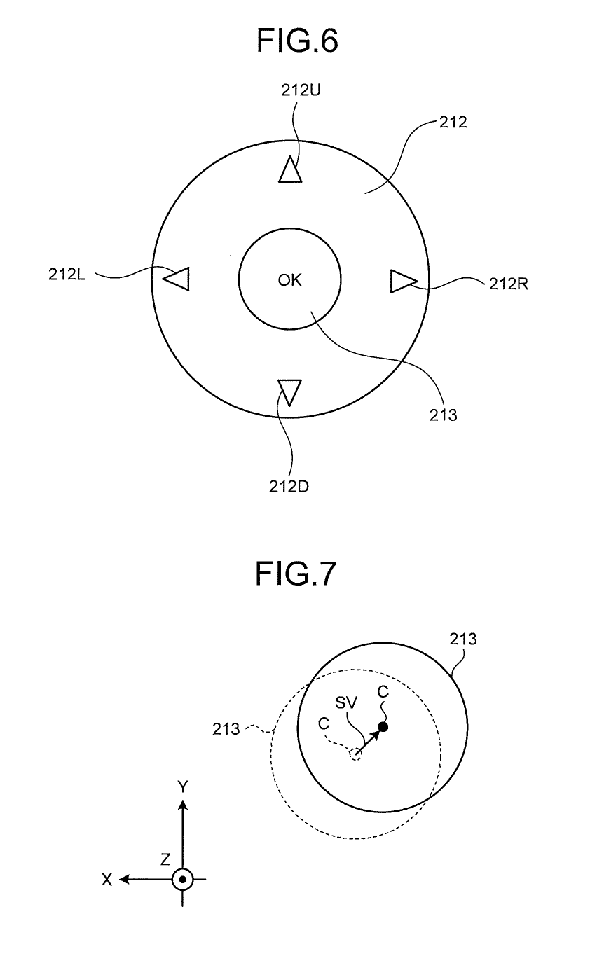

FIG. 6 is an enlarged schematic view of the direction key 212 and the center key 213 arranged on the upper housing 21. As illustrated in FIG. 6, the direction key 212 is formed in a a flat ring-like shape and is assigned four directions. In the remote controller 20 of the embodiment, an up key 212U, a down key 212D, a left key 212L, and a right key 212R represent the four directions. By specifying each of the four directions, a focus displayed on the display screen of the operated device can be moved. The movement of a focus means to move the focus to a predetermined option item (object) displayed on the display screen of the display device 16. The focus is configured to be movable only to option items.

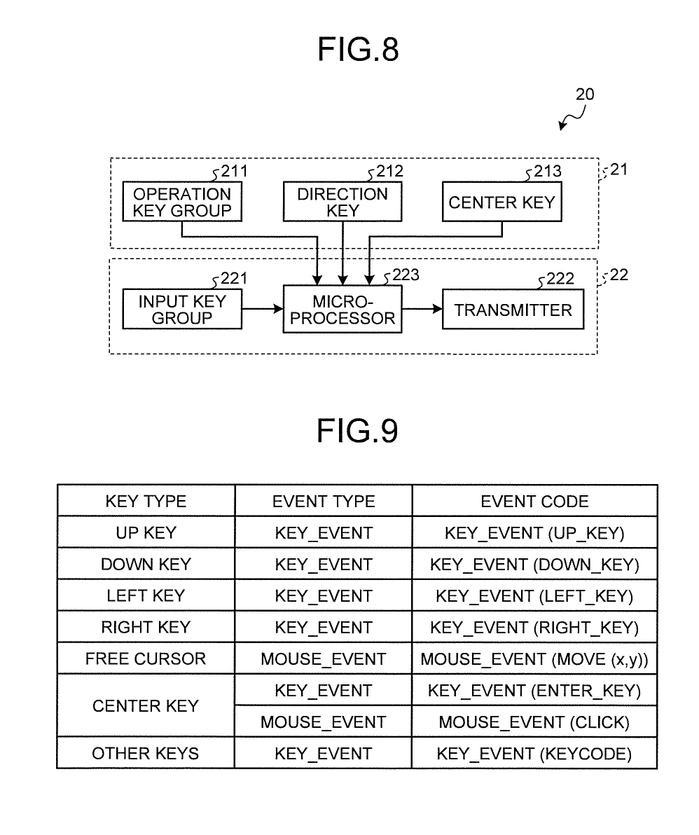

The center key 213 is arranged at the center of the ring shape of the direction key 212. As described above, the center key 213 functions as a pointing device. Specifically, as illustrated in FIG. 7, the center key 213 is configured as a pointing stick capable of sliding in X-axis and Y-axis directions and is slid by the user in any direction to move a pointer displayed on the display screen of the operated device. In FIG. 7, the broken line indicates the position of the center key 213 in non-operation state, and the solid line indicates the position of the center key 213 after being slid. A slide amount SV indicates a displacement amount (X component and Y component) from the position of a center C of the center key 213 in the non-operation state to the position of the center C of the center key 213 after being slid.

The center key 213 is configured to be capable of being pressed in the vertical direction (Z-axis direction) and is pressed by the user to instruct various determination operations. Specifically, the center key 213 is configured to instruct the determination operation at a focus position or the selection operation at a pointer position when pressed under the control of the microprocessor 13.

“The determination operation at a focus position” means to instruct to perform a predetermined function or process associated with an option item on which the focus is placed, and corresponds to the pressing of an enter key on a keyboard (an input key group 221). As just described, “the determination operation at a focus position” corresponds to the pressing of an enter key, and thus can be used for determination operation to input characters (for example, character conversion and line feed). “The selection operation at a pointer position” means to select an area (not necessarily an option item) where the pointer is located and corresponds to a single click on a mouse.

As described above, in the remote controller 20 of the embodiment, the center key 213 implements a function as a pointing device for operating a pointer and a function to instruct the determination operation at a focus position and the selection operation at a pointer position.

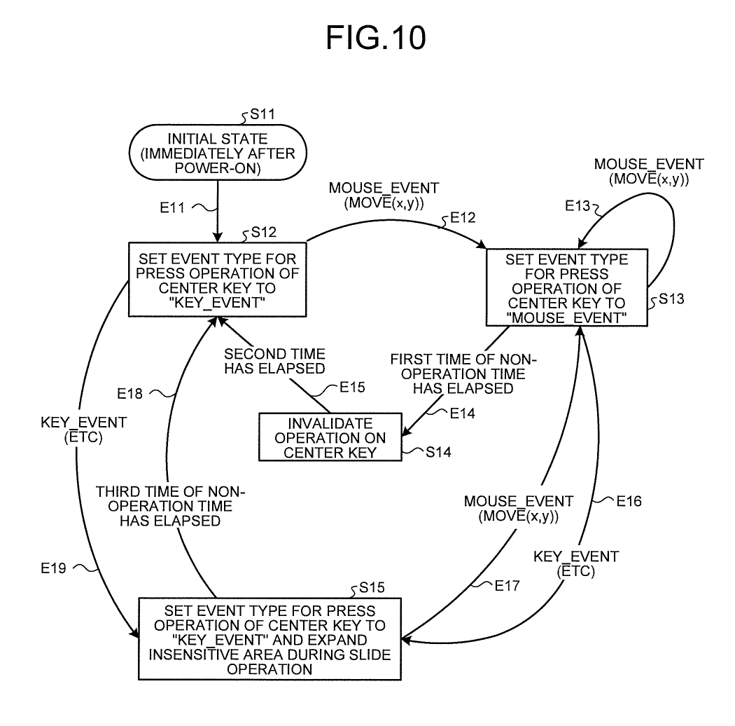

As illustrated in FIGS. 3 and 5, the upper housing 21 houses a key holder 21a that holds the operation key group 211, the direction key 212, and the center key 213, and a circuit board 21b comprising a reference potential pattern, a back light (not illustrated), and the like. The operation information of the key operation performed on the upper housing 21 is output to a microprocessor 223 (see FIG. 8) of the lower housing 22 via the rotatable joint 23.

The input key group 221 including an enter key for inputting letters or characters is arranged on an operation surface, i.e., the upper surface of the lower housing 22. In other words, the input key group 221 is arranged on the surface facing the bottom surface of the upper housing 21. The input key of the input key group 221 is pressed by the user to transmit a signal (a key code) representing a number or a letter corresponding to a pressed input key to the operated device.

As illustrated in FIG. 3, a transmitter 222 comprising a communication module using an infrared light-emitting diode (LED) or Bluetooth (registered trademark) is provided on the front surface (upper side in FIG. 3) of the lower housing 22. The operation performed by the user on the upper housing 21 or the lower housing 22 is to be sent as an event code, which will be described later, from the transmitter 222 to the operated device. As illustrated in FIGS. 3 and 5, the lower housing 22 houses a key holder 22a that holds the input key group 221 arranged on the operation surface, a circuit board 22b comprising a reference potential pattern (not illustrated), the microprocessor 223 (see FIG. 8), which will be described later, and the like, and a battery (not illustrated) as a power source.

The rotatable joint 23 connects the upper housing 21 and the lower housing 22 to be relatively rotatable about the rotation axis AX. The rotation axis AX of the rotatable joint 23 lies in the upper housing 21 and the lower housing 22 at the center in the longitudinal direction and the lateral direction.

As illustrated in FIGS. 2 and 3, the rotatable joint 23 holds the upper housing 21 and the lower housing 22 at a position where the outer edges of the upper housing 21 and the lower housing 22 are aligned in the closed state of the remote controller 20. If the lower housing 22 is rotated in an arrow R direction of FIG. 4 to be in open state, the rotatable joint 23 rotates to the position where the angle that the upper housing 21 and the lower housing 22 form becomes a substantially right angle as viewed from the rotation axis AX direction (Z-axis direction). This exposes the input key group 221 (see FIG. 4). In this manner, the remote controller 20 can accommodate the input key group 221 to overlap the upper housing 21 in the closed state where the input key group 221 is not operated. Thus, the remote controller 20 can be configured compact as a whole.

The hardware configuration of the remote controller 20 will be described below with reference to FIG. 8. FIG. 8 is a block diagram of a hardware configuration of the remote controller 20. As described above, the remote controller 20 comprises the operation key group 211, the direction key 212, and the center key 213 on the upper housing 21. The remote controller 20 further comprises, in addition to the input key group 221 and the transmitter 222 mentioned above, the microprocessor 223 in the lower housing 22. Modules of the operation key group 211, the direction key 212, the center key 213, the input key group 221, and the transmitter 222 are connected to the microprocessor 223 via a connector (not illustrated) or the like.

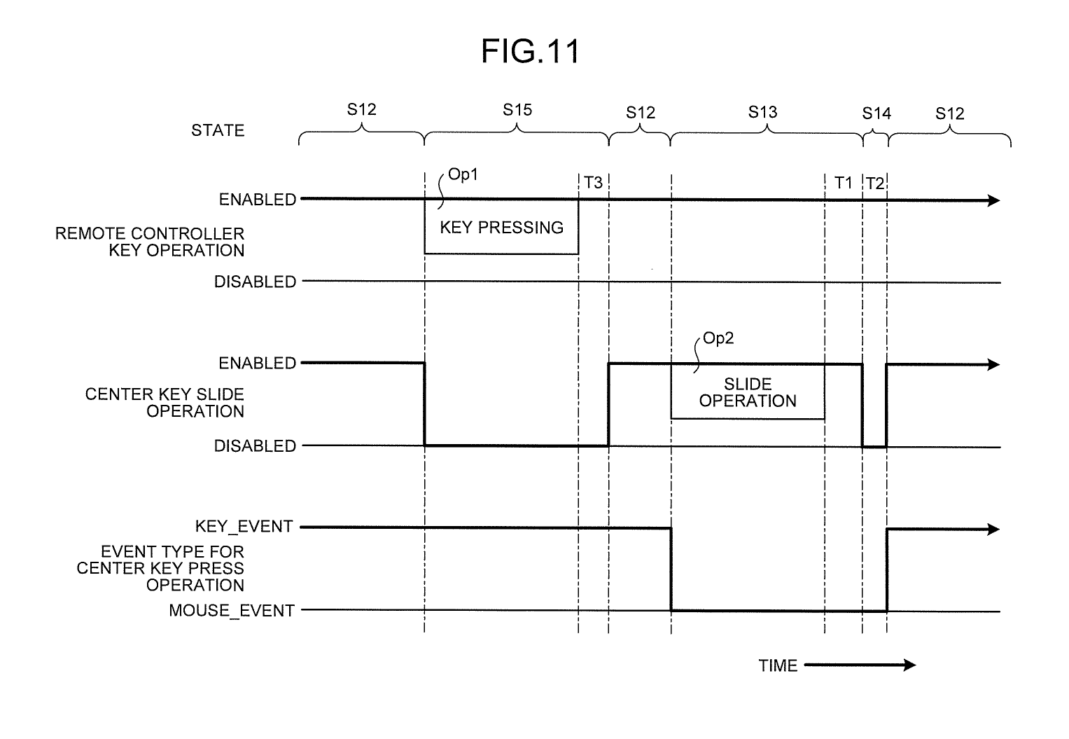

The microprocessor 223 is a controller responsible for the control operation of the remote controller 20. The microprocessor 223 receives operation on various keys performed by the user on the remote controller 20, and sends an event code (see FIG. 9) corresponding to the operation to the remote controller 20 through the transmitter 222. The microprocessor 223 cooperates with a clock such as a real time clock (RTC), and thus has a function of measuring elapsed time.

FIG. 9 is a table indicating correspondence between the key type of the remote controller 20, and the event type and the event code thereof. The relationship between the key type and the event type as well as the event code illustrated in FIG. 9 is stored in advance as a table or the like in a storage area (not illustrated) that the microprocessor 223 can refer to.

In FIG. 9, the key types “up key”, “down key”, “left key”, and “right key” correspond to the up key 212U, the down key 212D, the left key 212L, and the right key 212R of the direction key 212, respectively (see FIG. 6). The event type set to the press operation of the direction key 212 is “KEY_EVENT”. When the direction key 212 is pressed, an event code in which information indicating the pressed direction added to the event type “KEY_EVENT” is issued. For example, when the up key 212U is pressed, an event code “KEY_EVENT (UP_KEY)” is sent to the broadcast receiver 10.

A key type “free cursor” is an item corresponding to the slide operation of the center key 213. The event type set to the slide operation of the center key 213 is “MOUSE_EVENT”. When the center key 213 is slid, an event code “MOUSE_EVENT (MOVE (x,y))” in which a slide amount (X component and Y component) is added to the event type “MOUSE_EVENT” is issued.

A key type “center key” is an item corresponding to the press operation of the center key 213. Two event types are set to the press operation of the center key 213 including “KEY_EVENT” and “MOUSE_EVENT”. The event type “KEY_EVENT” is set when the press operation of the center key 213 corresponds to the determination operation at a focus position. In this case, when the center key 213 is pressed, an event code “KEY_EVENT (ENTER_KEY)” in which information indicating the determination operation at a focus position is added to the event type “KEY_EVENT” is issued.

On the other hand, the event type “MOUSE_EVENT” is set when the press operation of the center key 213 corresponds to a click at a pointer position. In this case, when the center key 213 is pressed, an event code “MOUSE_EVENT (CLICK)” in which information indicating the click operation at a pointer position is added to the event type “MOUSE_EVENT” is issued.

A key type “other keys” is an item corresponding to the press operation of any of keys (the operation key group 211 and the input key group 221) other than the direction key 212 and the center key 213. The event type set to the press operation of other keys is “KEY_EVENT”. When one of the other keys is pressed, an event code “KEY_EVENT (KEYCODE)” in which information indicating the pressed key is added to the event type “KEY_EVENT” is issued.

The microprocessor 223 transmits the event code corresponding to the operation performed on the remote controller 20 to the broadcast receiver 10 via the transmitter 222 based on the relationship illustrated in FIG. 9. The microprocessor 223 also switches the event type to be set to the press operation of the center key 213 based on the last operation.

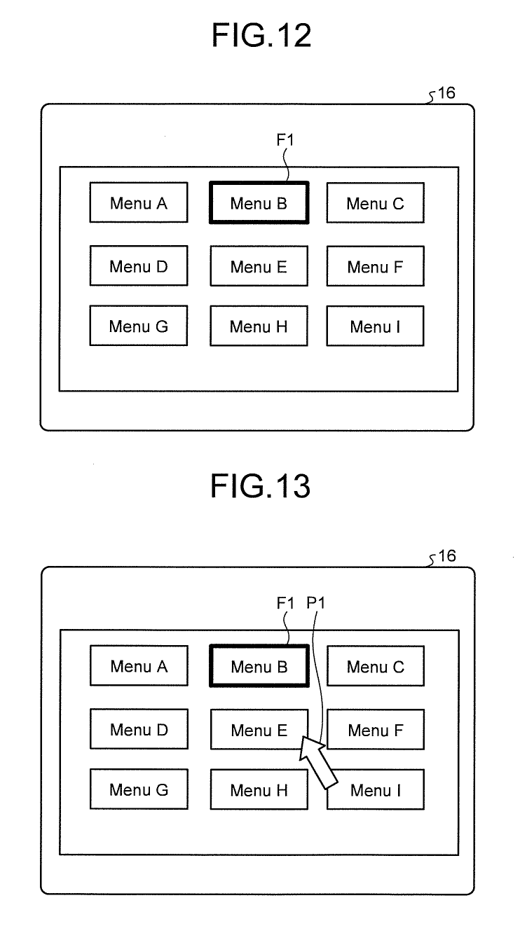

The switching operation of the event type to be set to the press operation of the center key 213 will be described below with reference to FIG. 10.

FIG. 10 illustrates the state transition of the event type set to the press operation of the center key 213. Setting information for implementing the state transition illustrated in FIG. 10 is stored in advance in a storage area (not illustrated) that the microprocessor 223 can refer to.

In an initial state of the remote controller 20 (or the broadcast receiver 10) immediately after the power is turned on (State S11), the microprocessor 223 sets the event type for the press operation of the center key 213 to “KEY_EVENT” (Edge E11→State S12). If the center key 213 is pressed in State S12, the microprocessor 223 sends the event code “KEY_EVENT (ENTER_KEY)” to the broadcast receiver 10.

If the center key 213 is slid in State S12, the microprocessor 223 sends the event code “MOUSE_EVENT (MOVE (x,y))” corresponding to the slide operation to the broadcast receiver 10 (Edge E12). A pointer displayed on the display device 16 moves in response to this operation. In this case, the determination operation in the event type “MOUSE_EVENT”, i.e., the selection operation at a pointer position, is likely to be successively performed. Accordingly, the microprocessor 223 sets the event type for the press operation of the center key 213 to “MOUSE_EVENT” according to the last operation (Edge E12) (State S13).

If the center key 213 is further slid in State S13, the microprocessor 223 sends the event code “MOUSE_EVENT (MOVE (x,y))” corresponding to the slide operation to the broadcast receiver 10 (Edge E13), and the state returns to the State S13 again. When the center key 213 is pressed in State S13, the microprocessor 223 sends the event code “MOUSE_EVENT (CLICK)” to the broadcast receiver 10.

The microprocessor 223 measures non-operation time of the remote controller 20 in State S13, and when a predetermined first time (for example, 4.5 seconds) has elapsed (Edge E14), the operation on the center key 213 is disabled for a predetermined second time (for example, 0.5 second) (State S14). When the second time has elapsed (Edge E15), the state returns to State S12 again, and the event type for the press operation of the center key 213 is set to “KEY_EVENT”. In the process of Edge E15, a code (for example, MOUSE_EVENT (NULL)) to notify that “MOUSE_EVENT” is switched to “KEY_EVENT” is sent to the broadcast receiver 10.

In such a manner, by providing the second time during which the operation of the center key 213 is disabled, operation error (malfunction) occurring when the center key 213 is operated while “MOUSE_EVENT” is switched to “KEY_EVENT” can be prevented. Thus, the operability of the remote controller 20 can be more enhanced. The second time during which the operation of the center key 213 is disabled is preferably shorter than the first time that is a threshold of the non-operation time (0≦second time<first time). State S13 may be maintained without measuring the non-operation time.

When any of the operation key group 211, the direction key 212, or the input key group 221 (hereinafter, collectively referred to as “remote controller key”) is operated in State S13, the microprocessor 223 sends an event code “KEY_EVENT (ETC)” corresponding to the operated key to the broadcast receiver 10 (Edge E16). “ETC” indicates the key code of the operated key (for example, “UP_KEY” in the case of the up key 212U).

With this, display on the display device 16 changes according to the operated key. In this case, the determination operation in the event type “KEY_EVENT”, i.e., the determination operation at a cursor position or during character input is likely to be successively performed. Accordingly, the microprocessor 223 sets the event type for the press operation of the center key 213 to “KEY_EVENT” according to the last operation (Edge E16), and expands an insensitive area during the slide operation of the center key 213 (State S15).

The expansion of the insensitive area means that the slide operation is not received until the slide amount of the center key 213 reaches or exceeds a predetermined value. In this manner, by expanding the insensitive area during the slide operation, if the slide operation is performed by mistake while the center key 213 is pressed, the state can be prevented from transiting to another state (Edge E17, which will be described later) due to the slide operation. Thus, the operability of the remote controller 20 can be more enhanced. In State S15, the slide operation of the center key 213 may be disabled.

If the center key 213 is slid beyond the insensitive area in State S15, the microprocessor 223 sends the event code “MOUSE_EVENT (MOVE (x,y))” corresponding to the slide operation to the broadcast receiver 10 (Edge E17). Accordingly, the microprocessor 223 sets the event type for the press operation of the center key 213 to “MOUSE_EVENT” according to the last operation (Edge E17) as in the case of Edge E12 (State S13).

The microprocessor 223 measures non-operation time of the remote controller 20 in State S15, and when a predetermined third time (for example, 1 second) has elapsed (Edge E18), the state returns to State S12 again and cancels the setting of the insensitive area.

In this State S12, if the remote controller key is operated, the microprocessor 223 sends the event code “KEY_EVENT (ETC)” corresponding to the operated key to the broadcast receiver 10 (Edge E19). The microprocessor 223 causes the state to transit to State S15 according to the last operation (Edge E19), and expands the insensitive area during the slide operation of the center key 213.

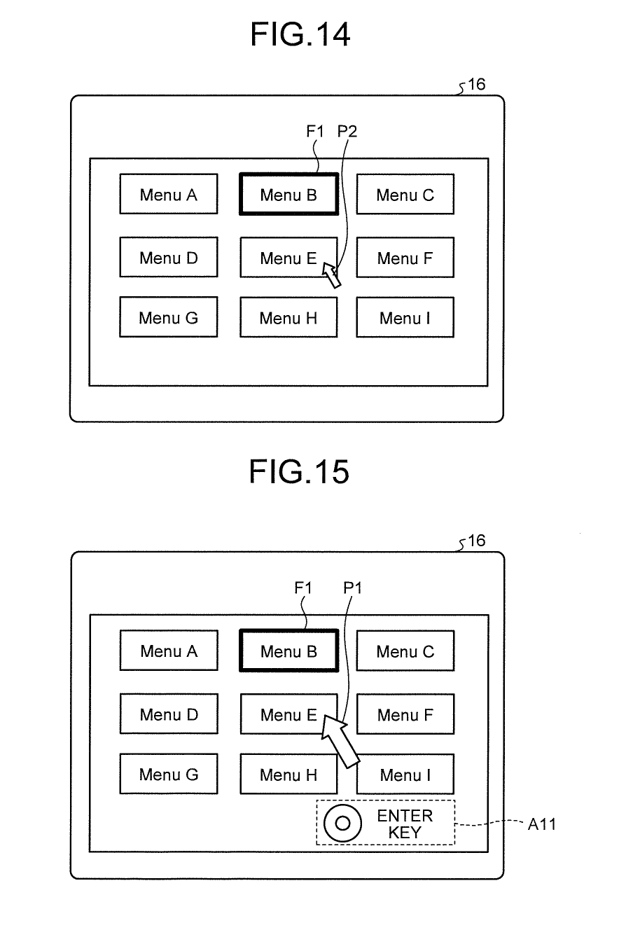

FIG. 11 is a timing chart illustrating an example of the state transition illustrated in FIG. 10. In FIG. 11, periods of States S12 to S15 correspond to State S12 to S15 illustrated in FIG. 10, respectively. The time elapses in an arrow direction of FIG. 11.

In the period of the initial State S12, the press operation of the remote controller key (the operation key group 211, the direction key 212, and the input key group 221) and the slide operation of the center key 213 (pointer movement) are enabled. The event type for the press operation of the center key 213 is set to “KEY_EVENT”. The press operation of the remote controller key is consistently enabled, and thus, the description is not provided below.

When the state transits to State S15 in response to pressing of the remote controller key (Op1), the insensitive area of the center key 213 is expanded or the slide operation is disabled to partially or entirely disable the slide operation of the center key 213. When the non-operation time reaches the third time after the remote controller key is pressed (T3 in FIG. 11), the state returns to State S12 again and the slide operation of the center key 213 is enabled again. During these periods, the event type for the press operation of the center key 213 is maintained at “KEY_EVENT”.

Subsequently, when the state transits to State S13 in response to sliding of the center key 213 (Op2), the event type for the press operation of the center key 213 is switched to “MOUSE_EVENT”. When the non-operation time reaches the first time+the second time (T1+T2 in FIG. 11) after the slide operation, the state returns to State S12 again and the event type for the press operation of the center key 213 is switched to “KEY_EVENT”. If the second time is other than 0, the state transits to State S14 and the operation of the center key 213 is disabled during the second time (see T2 in FIG. 11).

As described above, according to the embodiment, the event type set to the press operation of the center key 213 is switched according to the last operation on the remote controller 20. With this, the focus operation and the cursor operation can be efficiently performed. Thus, the operability of the remote controller 20 can be enhanced.

Described below is the operation of the broadcast receiver 10 while an event code is received from the remote controller 20. FIGS. 12 and 13 illustrate examples of the operation of the broadcast receiver 10 during receipt of an event code and examples of a screen displayed on the display device 16. In this screen, “Menu A” to “Menu I” are an object group serving as option items of a focus F1, and the operation of the direction key 212 can move the focus F1 to any of the option items. In the examples of FIGS. 12 and 13, the focus F1 is placed on “Menu B”.

The microprocessor 13 determines the event type set to the press operation of the center key 213 of the remote controller 20 based on the event type contained in the event code received from the remote controller 20. Having determined that the event type “KEY_EVENT” is set, the microprocessor 13 displays only the focus F1 as illustrated in FIG. 12 to notify the user that the event type “KEY_EVENT” is set to the press operation of the center key 213. Having determined that the event type “MOUSE_EVENT” is set, the microprocessor 13 displays a pointer P1 as illustrated in FIG. 13 to notify the user that the event type “MOUSE_EVENT” is set to the press operation of the center key 213.

In such a manner, the broadcast receiver 10 changes the screen displayed on the display device 16 depending on the event type received from the remote controller 20 to notify the user of the event type set to the press operation of the center key 213. Accordingly, the user operating the remote controller 20 can understand whether the determination operation at a focus position or the click operation at a pointer position is performed by pressing the center key 213.

The event type notification is not limited to the examples of FIGS. 12 and 13 and may be performed in other manners. For example, as illustrated in FIG. 14, if the event type “KEY_EVENT” is set, a pointer P2 smaller than the pointer P1 illustrated in FIG. 13 may be displayed. In this case, the user can be notified of the event type set to the press operation of the center key 213 by the size of pointers.

Moreover, the event type set to the press operation of the center key 213 and functional meaning of the press operation of the center key 213 may be directly displayed on the screen. For example, as illustrated in an area A11 of FIG. 15, if the event type “KEY_EVENT” is set, “Enter Key” may be displayed as functional meaning of the press operation of the center key 213. On the other hand, as illustrated in an area A12 of FIG. 16, if the event type “MOUSE_EVENT” is set, “Pointer Click” may be displayed as functional meaning of the press operation of the center key 213.

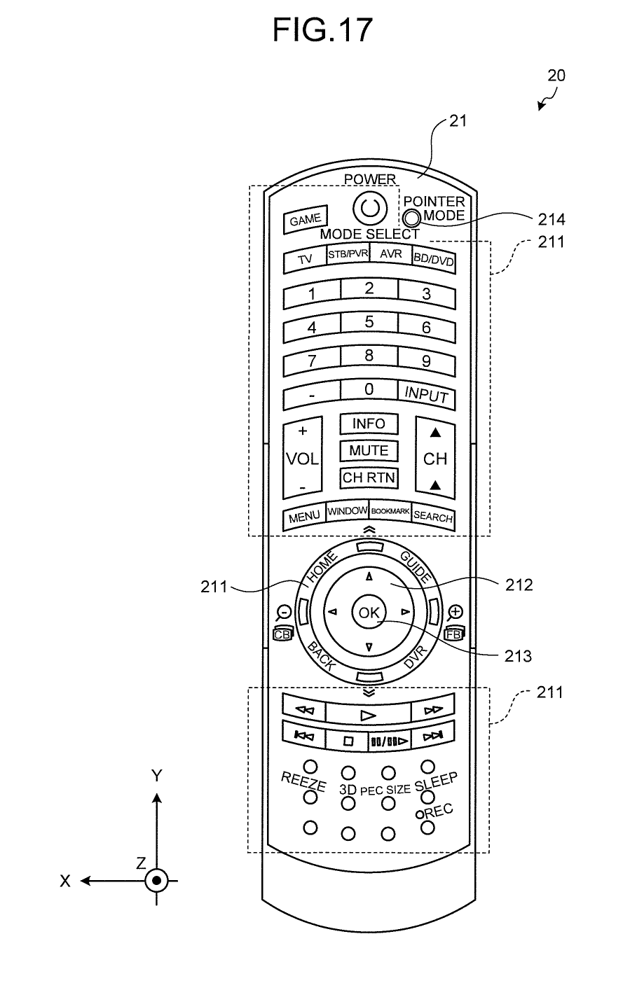

As illustrated in FIG. 17, if the remote controller 20 comprises an indicator 214 capable of indicating the event type set to the press operation of the center key 213, the event type set to the press operation of the center key 213 may be indicated on the remote controller 20 by the indicator 214. When a backlight is individually provided to the center key 213, the light color of the backlight may be changed depending on the event type to notify the user of the event type.

For example, in the above embodiment, the function of a pointing device for operating a pointer and the function of instructing the determination operation at a focus position or the selection operation at a pointer position are implemented with the single center key 213. However, it is not so limited and dedicated operation keys may be individually provided to different functions, respectively.

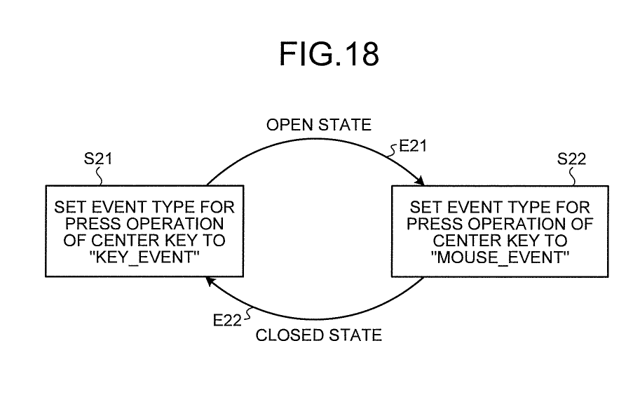

While, in the above embodiment, the remote controller 20 is described as having double stacked structure as illustrated in FIGS. 2 to 5, it is not so limited. The embodiment may also be applied to, for example, a straight-type remote controller comprising only operation keys of the upper housing 21. For the use of the remote controller 20 configured as described in the above embodiment, a detector (not illustrated) capable of detecting the open or closed state of the remote controller 20 may be additionally provided and the event type set to the press operation of the center key 213 may be switched depending on the open or closed state of the remote controller 20. An example of this switching operation will be described below with reference to FIG. 18.

FIG. 18 illustrates another example of the state transition of the event type set to the press operation of the center key 213. In the example of FIG. 18, pressing of the center key 213 is used as an enter key while the remote controller 20 is in closed state. On the other hand, while the remote controller 20 is in open state, pressing of the center key 213 is used as a click key, and an enter key in the input key group 221 is also used.

In the closed state of the remote controller 20, the microprocessor 223 sets the event type for the press operation of the center key 213 to “KEY_EVENT” (State S21). In State S21, if the remote controller 20 is brought to open state (Edge E21), the microprocessor 223 sets the event type for the press operation of the center key 213 to “MOUSE_EVENT” according to this operation (State S22). In State S22, if the remote controller 20 is brought to closed state (Edge E22), the microprocessor 223 sets the event type for the press operation of the center key 213 to “KEY_EVENT” according to this operation (State S21).

As described above, the focus operation and the cursor operation can be efficiently performed by switching the event type assigned to the press operation of the center key 213 depending on the open or closed state of the remote controller 20. Thus, the operability of the remote controller 20 can be enhanced.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of controlling a remote controller that comprises a first key configured to move a focus displayed on a display screen, a second key configured to move a pointer displayed on the display screen, and a third key configured to instruct determination operation at a focus position or selection operation at a pointer position, the method comprising:
receiving operation on the remote controller; and
switching operations to be instructed by the third key according to last operation received at the receiving.

2. The method of of claim 1, wherein
if the last operation received at the receiving is moving the focus, operation instructed by the third key is set to the determination operation at the focus position at the switching, and
if the last operation received at the receiving is moving the pointer, operation instructed by the third key is set to the selection operation at the pointer position at the switching.

3. The method of of claim 1, wherein
the remote controller further comprises a key other than the first key, the second key, and the third key, and
if the last operation received at the receiving is related to the key, operation instructed by the third key is set to the determination operation at the focus position at the switching.

4. The method of claim 1, further comprising indicating operation set for the third key at the switching.

5. The method of claim 1, wherein functions of the second key and the third key are implemented by an identical operation key.

6. The method of claim 5, wherein
the first key is formed with a ring-like shaped direction key that is assigned predetermined directions, and
the operation key is located at a center of a ring-like shape of the direction key.

7. The method of claim 1, wherein
the remote controller comprises
a substantially rectangular parallelepiped first housing comprising an upper surface on which the first key, the second key, and the third key are arranged,
a substantially rectangular parallelepiped second housing comprising an upper surface on which input keys configured to input letters are arranged, and
a joint configured to connect the first housing and the second housing to be relatively rotatable about a center such that a bottom surface of the first housing overlaps the upper surface of the second housing, and
the joint is configured to rotate to a position where an angle that a longitudinal direction of the first housing and a longitudinal direction of the second housing form a substantially right angle and expose the input keys to allow the input keys to be operated.

8. The method of claim 7, further comprising detecting open state and closed state of the first housing and the second housing, wherein
the switching include switching the operation instructed by the third key depending on the open state or the closed state of the first housing and the second housing.

9. A remote controller comprising:
a first key configured to move a focus displayed on a display screen;
a second key configured to move a pointer displayed on the display screen;
a third key configured to instruct determination operation at a focus position or selection operation at a pointer position;
a receiver configured to receive operation on the first key, the second key, and the third key; and
a switching module configured to switch operations to be instructed by the third key according to last operation received by the receiver.

10. A display system comprising:
an electronic device comprising a display device configured to display a predetermined image on a display screen; and
a remote controller configured to remotely operate the electronic device, the remote controller comprising
a first key configured to move a focus displayed on a display screen;
a second key configured to move a pointer displayed on the display screen;
a third key configured to instruct determination operation at a focus position or selection operation at a pointer position;
a receiver configured to receive operation on the first key, the second key, and the third key; and
a switching module configured to switch operations to be instructed by the third key according to last operation received by the receiver.
